(19) United States
(12) Patent Application Publication
(10) Pub. No.: US 2001/0030011 A1
(43) Pub. Date: Oct. 18, 2001

(54) Method of gluing and apparatus therefor

(76) Inventors: Benyahia Nasli-Bakir, Saltsjo-Boo (SE); Lars Olsson, Tyreso (SE); Patrick Ranvier, Drancy (FR)

Correspondence Address: David J. Serbin, Unit 2, First Floor, 1423 Powhatan Street, Alexandria, VA, 22314, US

(21) Appl. No.: 09/741,095

(22) Filed: Dec. 21, 2000

Related U.S. Application Data
(60) Provisional application No. 60/174,596, filed on Jan. 5, 2000.

(30) Foreign Application Priority Data
Dec. 30, 1999 (EP) 99850221.5

(51) Int. Cl. B32B 31/00

(52) U.S. Cl. 156/64; 156/362; 156/356; 156/556; 156/578; 156/580

(57) ABSTRACT

The invention relates to a method of manufacturing composite products. Thereby a number of elements to be assembled is provided and glue is applied to at least one surface of each element. The elements are assembled, and the assembled elements are subjected to pressure in a press. The invention is characterized in that amount of at least one component of the glue, applied at a specific point of glue application on an element, is controlled to be a function of the waiting time it takes before the point of glue application is subjected to the pressure in the press. It also relates to an apparatus for carrying out the method which is caracterized by a control unit (15) which is programmable to run a control sequence for the glue applicator (10) and/or the element feeder (6; 16) to provide an optimal applied glue amount.

The present invention relates to the manufacture of composite products, wherein a plurality of elements are assembled by gluing them together. In particular it relates to mechanical application of glue in such manufacture.

### BACKGROUND OF THE INVENTION

For the manufacture of products comprising a plurality of elements that are assembled by gluing, sometimes large amounts of glue are applied to large surfaces. In cases where several elements exhibiting such large surfaces are to be assembled one after the other, substantial waiting times may occur before the assembly of elements can be finally processed e.g. in a press, where the curing of the glue takes place. In such instances, for example, in the production of laminated wood, the first element to which glue was applied will have to wait longer than the last element. The amount of glue that is applied to each element is calculated based on the waiting time for the element that has the longest waiting time. This leads to a waste of glue and therefore economic disadvantage.

Commonly used glues are e.g. PRF (Phenol Resorscinol Formaledhyde; two component glue), MUF (Melamine Urea Formaldehyde; two component glue), PUR (Poly urethane; one component glue). In the case of two components, each component can be applied separately or they can be mixed before application.

### SUMMARY OF THE INVENTION

Thus, the present invention seeks to provide a method and apparatus that reduces the total amount of glue that is used in the manufacture of composite structures.

The method according to the invention is defined in claim 1.

By controlling the amount of at least one component of a glue applied in relation to the waiting time before a glued object is subjected to final compression treatment in a press, a reduction in glue consumption is achieved.

Preferably the amount of glue is also adapted to other factors such as moisture content in the material to be glued and in the ambient atmosphere, hardness of the material, porosity etc.

A number of different materials can be processed, e.g. metal, polymers, ceramics, wood. In preferred embodiments the material to be processed by the method of the invention is wood.

An apparatus for manufacturing composite products using an optimal amount of glue is defined in claim 14, and an apparatus for the controlled glue application is defined in claim 17.

### BRIEF DESCRIPTION OF THE DRAWINGS

FIG. 1 schematically shows a manufacturing station for the production of glued structures;

FIG. 2a shows one type of press;

FIG. 2b shows an example of the glue application profile according to the invention for the press of FIG. 2a;

FIG. 3a shows another type of press;

FIG. 3b shows an example of the glue application profile according to the invention for the press of FIG. 3a;

FIG. 4a shows a third type of press;

FIG. 4b shows an example of the glue application profile according to the invention for the press of FIG. 4a; and

FIG. 5 is a flow chart of an embodiment of the control process.

### DETAILED DESCRIPTION OF THE INVENTION

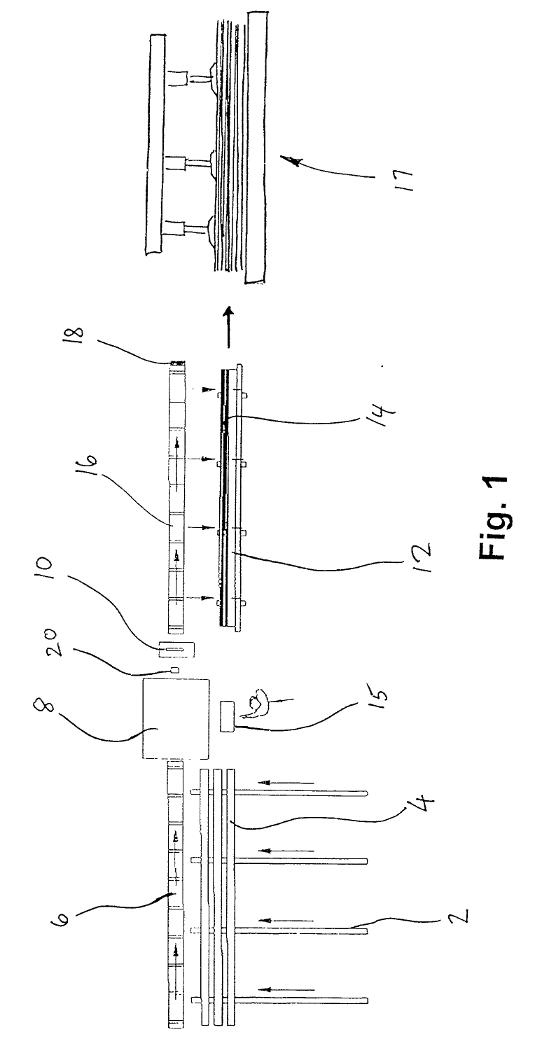

A first embodiment of the invention will now be described with reference to the manufacture of a laminated beam consisting of a stack of individual lamellas glued and pressed together to form the beam, and a schematic illustration of a manufacturing station for this purpose is shown in FIG. 1. However, the principle is usable for all kinds of products that are glued together and subjected to pressure for glue hardening purposes.

The manufacturing station comprises a supply unit 2 for individual lamellas 4. The supply unit can be any kind of transport device that is able to position one lamella at a time on a conveyor belt 6 or the like, used for feeding the lamellas into the processing portion of the manufacturing station. The supply unit could even be an operator, manually placing each individual lamella on said conveyor.

The processing portion comprises in the shown embodiment five units: a planer device 8; a glue applicator 10; a stacking unit 12 where a “precursor beam” 14 is assembled; a control unit 15 (e.g. a PC or other micro processor device) and operating panel; and a press 17.

The control unit 15 is supplied with data for the specific product to be manufactured, either by an operator or in digital form from a central computer or by data on diskettes etc. Details of the control program will be given below.

The procedure is thus the following: a first lamella 4 is placed on the conveyor or feeder 6, fed into the planer device 8, where the lamella is suitably surface machined. This unit comprises guide rolls and machining tools, and therefore it can also be used for controlling the speed of the lamella through the station. However, the planer device can be dispensed with if the raw material is of high quality and does not need to be treated, and if the speed of the lamellas can be controlled by the conveyor 6, or by the glue applicator 10.

After having (optionally) been surface machined, the lamella 4 is fed through the glue applicator 10. The glue amount that is applied to the lamella is controlled in a way to be described below, and will vary from lamella to lamella automatically according to the control program, adapted for each individual product type and environmental conditions prevailing in the plant.

After having been provided with the appropriate amount of glue, the lamella 4 on exiting from the glue applicator 10 will be moved forwards by a second conveyor 16 to a stop 18. Then, the lamellas will be moved from the conveyor 16 to the side where they are placed on top of each other until the desired number of lamellas have been assembled to a pile or stack. The assembly is then transported to a press where the pile is subjected to a suitable pressure, and if required to heat, for a sufficient period of time to harden the glue. This part of the process does not form part of the invention per se, and is common knowledge for the skilled man, and will therefore not be described in further detail.

Preferably there will be provided a sensor 20 for counting the number of lamellas passing the glue applicator, or for measuring the number of linear meters that has been fed through the station. The data from the sensor is fed to the control unit 15.

There are several possible types of press usable for the manufacture of laminated products.

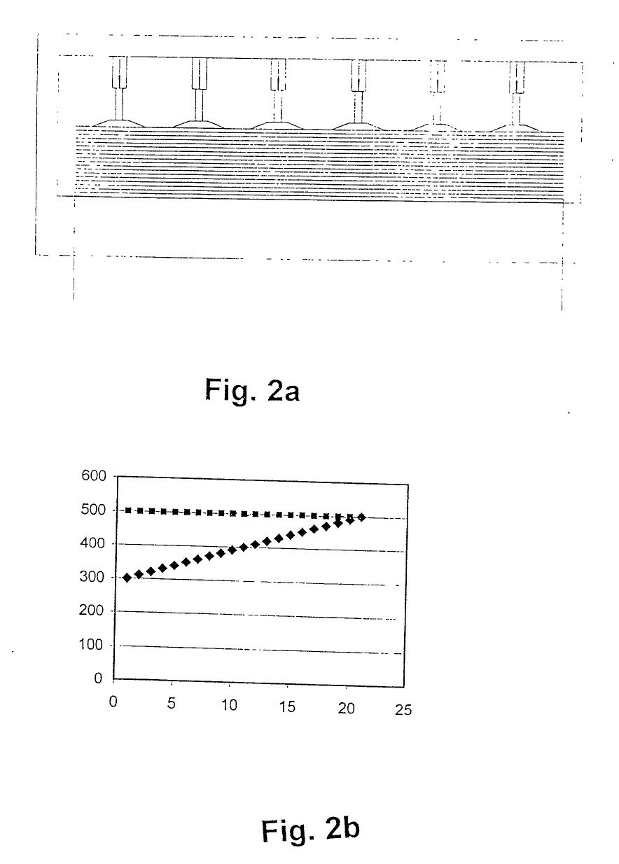

A first example is shown in FIG. 2a. It is a full length press, i.e. it will exert a pressure over the entire assembly of glued lamellas at one and the same time, and thus all parts will be pressed simultaneously, therefore the pressing operation itself will not cause any additional waiting times that must be considered in the glue application.

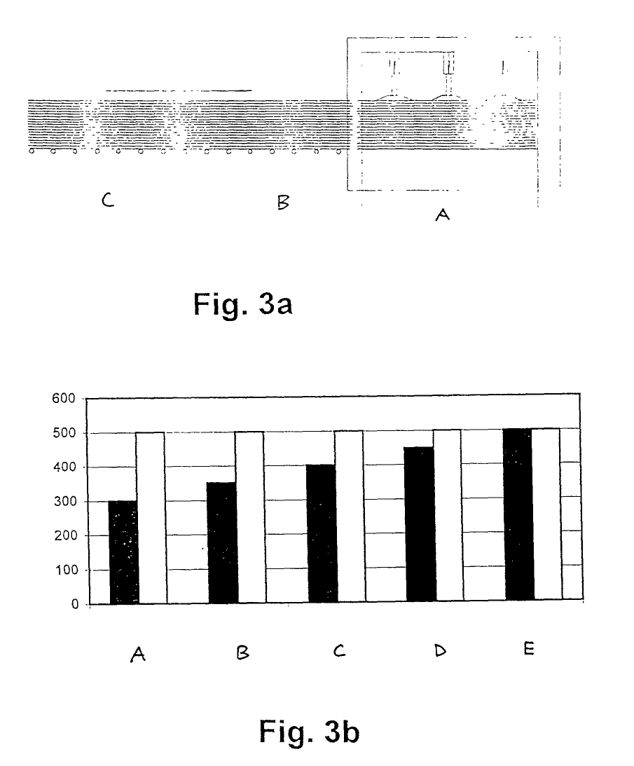

In contrast, the press shown in FIG. 3a, which is a section press, will press only part of the assembly in a first pressing operation, and then continue along the length of the assembly in several operations, that may or may not be overlapping. In this case obviously the last section to be pressed has to wait additional time, and thus the amount of glue is optimized also in accordance therewith.

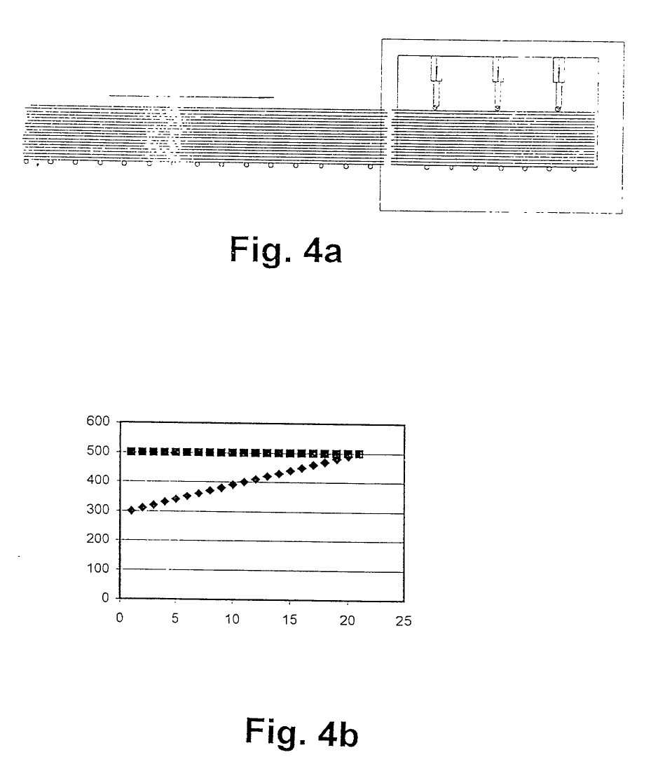

A third alternative is shown in FIG. 4a, which shows a continuously working press, i.e. the pressure is applied by means of rollers acting on the upper surface of the pile or stack of lamellas. The assembly is then fed continuously through the press.

Obviously the glue application profiles for these alternatives differ, and the profile for each respective type of press is shown in FIGS. 2b-4b.

In the case of a full length press, as already mentioned, there is no waiting time caused by the pressing operation as such, and the only waiting times to consider are the waiting times for each lamella during the gluing and stacking process. Thus, as shown in FIG. 2b there is a constant amount of glue applied over the entire surface or length of each lamella, but the amount of glue will differ between lamellas. ♦ designates the glue applied in accordance with the invention, and ▪ the traditional spread of glue.

In the second case, with sections pressed one at a time, there will obviously occur a waiting time between each consecutive pressing operation, and consequently the glue must be applied differently over the length of the lamellas. The glue amounts increase in increments over the length, and the glue application profile is shown by the left hand bars in the bar chart in FIG. 3b (the bars of equal length represent traditional glue spread). Thus, the section subjected to the compression first (section A in FIG. 3b) will have a smaller amount of glue applied than the following sections, since the waiting time is highest for the higher “numbered” sections.

In the continuous glue application case, there will of course be a continuously increasing amount of glue needed to be applied as a function of increasing waiting time, as clearly seen in FIG. 4b, wherein ♦ designates the amount of glue as a function of linear meters of product, according to the invention, and ▪ designates traditional glue application.

Of course the optimal application of glue would be a combination of a varying application on one hand between lamellas, but also over the length of a lamella.

The amount of glue to be applied to each element can be controlled in several ways.

It is possible to have the control unit control at least four different parts of the system shown in FIG. 1, namely a) the conveyor 6; b) the planer device 8; c) the glue applicator 10; and d) the second conveyor 16.

Thus, obviously the amount of glue that is applied to an element passing through the glue applicator 10, will change if the speed through the applicator changes; rapid movement will yield a thinner glue layer, and a slow movement a thick layer. As can be easily understood, by running at a constant speed and then simply reducing the speed abruptly at half length of an element, two distinct areas having different amounts of glue applied are achieved.

On the other hand it is equally easy to increase or decrease the speed continuously, thereby obtaining a linear “gradient” of glue over the length of an element.

For the simple case where there is only a need to change the amount between elements, the speed is kept constant over the entire length of each lamella. This would correspond to the situation in FIG. 2a where a full length press is used, and the bottom lamella is the first to which glue was applied, thus having the longest waiting time.

If the planer device 8 is used, as already indicated its guide rolls and/or machining tools can be used to force the lamellas 4 through the system, and thus the speed control can be obtained by controlling the planer device 8.

It is possible to use the second conveyor 16 too for speed control, although this would require slightly more complicated means. E.g. a connection to the conveyor would have to be provided such that the conveyor pulls the lamella through the applicator 8, thereby acting as a feeder device.

Of course the glue applicator itself can be used to control the amount of glue applied. Several possibilities exist. In the first place it is dependent on the type of applicator. An applicator normally is of either of a string type or of a curtain type. As indicated by these designations, the first applies only an essentially linear string of glue, preferably to narrow objects. A curtain applicator spreads the glue over a wide area, up to as much as several meters in width.

One way of controlling the amount of glue applied at a constant speed of the elements, is of course to control the pumped flow of the glue.

Another way is to change the “working” width of the ribbon spreader pipe, for a string type applicator simply by reducing or increasing the number of nozzles which are open, by turning the spreader pipe. For a curtain type of applicator the slit width can be varied.

Combinations of speed of element movement and of applicator settings are of course also conceivable.

In the case where a two-component adhesive is employed, it is possible to control the mixing ratio of hardener to glue. The more hardener the faster the hardening and the less the allowed waiting time. Thus, the first element of a series of elements to be assembled should be provided with adhesive, the ratio between hardener and glue of which should be lower than the ratio for the last element.

### EXAMPLES

In the following examples a glue of the PRF type has been used.

### Example 1

A construction beam made up of 21 pieces is manufactured by assembling lamellas and pressing in a full length press. The piece to which the glue is applied first has a waiting time of 1 hour, and the last piece has a waiting time of 10 minutes. The following glue application profile will be employed.

| Lamella No. | Amount of glue (g/m²) |
|---|---|
| 1 | 500 |
| 2 | 488 |
| 3 | 476 |
| 4 | 464 |
| 5 | 452 |
| . . . | |
| . . . | |
| 21 | 300 |

The profile is illustrated graphically in FIG. 2b for above assembly of 21 pieces.

The amount of glue per m² can of course vary, and commonly does so between 100-300 g/m² for 10 minutes waiting time, and between 300-500 g/m² for 1 hour waiting time. As already indicated above moisture content in the material, humidity in the atmosphere, ambient temperature, will also influence the amount glue to be applied.

### Example 2

A construction beam made up of 21 sections as in Example 1 is made, but instead of a full length press a section press is used (FIG. 3a). Thus, it becomes preferred to apply different amounts of glue on the various sections of each piece, in addition to varying the amount from one lamella to another, see FIG. 3b, wherein the black bars represent the glue application according to the invention, and the white bars represent traditional application. In the example the beam is pressed in 5 sections (A-E, where A is the section that will enter the press first).

| | Amount of glue (g/m²) on each section | | | | |
|---|---|---|---|---|---|
| Lamella No. | A | B | C | D | E |
| 1 | 342 | 392 | 442 | 492 | 542 |
| 2 | 340 | 390 | 440 | 490 | 540 |
| 3 | 338 | 388 | 438 | 488 | 538 |
| 4 | 336 | 386 | 436 | 486 | 536 |
| 5 | 334 | 384 | 434 | 484 | 534 |
| | . . . | | | | |
| | . . . | | | | |
| 21 | 300 | 350 | 400 | 450 | 500 |

In the pile of lamellas, lamella no. 21 will be the top lamella, thus having the shortest waiting time.

### Example 3

A construction beam made up of 21 lamellas as in Example 1 is made, but instead of a full length press a continuously operating press is used. Thus, it becomes preferred to apply a gradient of the amounts of glue over the length of each piece. Strictly speaking it is not necessary to apply a continuously changing amount, it would suffice to increment the amount as if the press is operated as a section press with a very large number of sections. In this context “very large” could mean 20 sections or more.

The profile in FIG. 4b adequately illustrates the required profile for one of the lamellas in a beam.

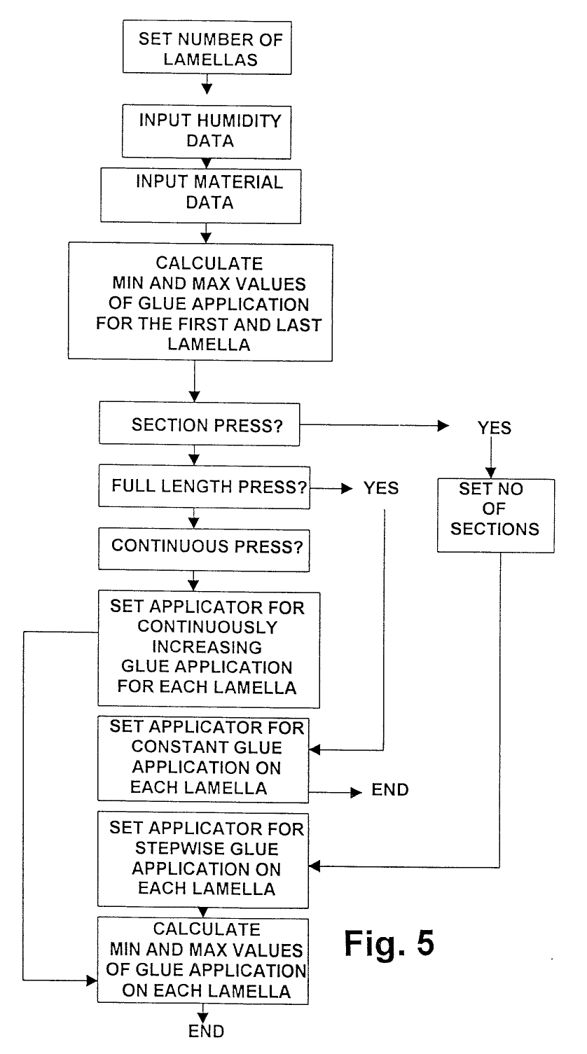

FIG. 5 is a flow chart that illustrates one embodiment of the control program for controlling the glue application in accordance with the inventive concept.

It assumes that a one-component glue is used, and that the process is for the manufacture of a beam comprising a number of lamellas to be assembled.

Thus, the first step is to set the number of lamellas to be assembled, and data relating to environment (e.g. humidity as in the example, although other factors might be considered too), and to material properties, e.g. hardness, porosity etc. From this input data and data from a data base containing information about glue behaviour under different circumstances, the necessary minimum and maximum glue amounts are calculated for each lamella.

Next, the type of press is selected, and in case of a section press, the number of sections is set. Also in response to the press selection, the glue applicator is set for constant application or stepwise or continuous change of glue application.

The invention has been describe with reference to some embodiments, but the skilled man will find various modifications without departing from the scope of invention as defined in the claims.

1. A method of manufacturing composite products, wherein a plurality of elements are assembled by gluing them together under pressure, comprising the steps of:
providing a number of elements to be assembled;
applying glue to at least one surface of each element;
assembling the elements to the desired structure; and
subjecting the assembled elements to pressure in a press;
controlling the amount of at least one component of the glue, applied at a specific point of glue application on an element, to be a function of the waiting time it takes before the point of glue application is subjected to the pressure in the press.

2. The method according to claim 1, wherein the glue is a multi-component adhesive, one component of which is a hardener and wherein the amount of one of said adhesive components is controlled so as to control the ratio between hardener and remaining components to be a function of the waiting time.

3. The method according to claim 2, wherein the glue is a two-component adhesive comprising hardener and a glue, the ratio hardener:glue is controlled to be lower for longer waiting times.

4. The method according to claim 1, wherein the glue is a one-component glue, and the amount of is increased as a function of increased waiting time.

5. The method according to claim 4 wherein the amount of glue applied to each element is constant over the surface of said element, but varies between elements.

6. The method according to claim 4, wherein the first element in a series of elements receives a smaller amount of glue than subsequent elements.

7. The method according to claim 4, wherein the amount of glue applied to each element varies over the surface of said element.

8. The method according to claim 4, wherein the amount of glue applied is controlled by controlling the speed of movement of the element(s) during glue application

9. The method according to claim 8, wherein the amount of glue applied is controlled by controlling the rate of application of glue onto the surface of each element.

10. The method according to claim 8, wherein the speed of movement is varied from one element to another.

11. The method according to claim 8, wherein the speed of movement is varied during the glue application on each element.

12. The method according to claim 11, wherein the speed of movement is varied stepwise or continuously.

13. The method according to claim 9, wherein the application rate is varied stepwise or continuously.

14. An apparatus for the manufacturing of composite products, wherein a plurality of elements are assembled by gluing them together under pressure, comprising
an element feeder (6; 16);
a glue applicator (10);
a stacking unit (12);
a control unit (15); and
a press (17);
said control unit (15) being programmable to run a control sequence for the glue applicator (10) and/or the element feeder (6; 16) to provide an optimal applied glue amount.

15. The apparatus as claimed in claim 12, wherein the control sequence is adapted to control the speed of movement of the feeder (6; 16), and thereby of the elements through the glue applicator (10).

16. The apparatus as claimed in claim 14, wherein the control sequence is adapted to control the rate of glue application to the elements.

17. An apparatus for the controlled application of glue to elements to be assembled to a composite structure, comprising
an element feeder (6; 16);
a glue applicator (10); and
a control unit (15);
said control unit (15) being programmable to run a control sequence for the glue applicator (10) and/or the element feeder (6, 16) to provide an optimal applied glue amount.
